(19) United States
(12) Patent Application Publication
(10) Pub. No.: US 2014/0314253 A1
(43) Pub. Date: Oct. 23, 2014

(54) VIBRATION CONDUCTION AND FREQUENCY-SELECTIVE AMPLIFICATION DEVICE FOR A MOVING-IRON MICROPHONE/TRANSDUCER

(71) Applicant: Wei Zhou, Suzhou (CN)

(72) Inventor: Wei Zhou, Suzhou (CN)

(73) Assignee: SUZHOU HEARONIC ELECTRONICS, Suzhou, Jiangsu (CN)

(21) Appl. No.: 14/348,782

(22) PCT Filed: Nov. 12, 2011
(86) PCT No.: PCT/CN2011/082120

§ 371 Date: Jun. 6, 2014

(30) Foreign Application Priority Data
Sep. 30, 2011 (CN) 201110291220.0

(51) Int. Cl. H04R 1/02; H04R 1/20

(52) U.S. Cl. CPC H04R 1/02; H04R 1/20
USPC 381/162

(57) ABSTRACT

A vibration conduction and frequency-selective amplification device for a moving-iron microphone/transducer, including connecting portions at both ends and a middle portion for vibration conduction and frequency-selective amplification. The device is mechanically connected to a microphone armature and a vibration diaphragm of the moving-iron microphone/transducer, and performs frequency-selective amplification on a vibration generated by the armature and transmits the vibration onto the diaphragm by the middle portion, so as to achieve frequency-selective amplification and conversion from mechanical energy to acoustic energy. The device includes a frequency-selective amplification function, and may adjust mechanical configurations and connecting portions according to different requirements to enrich the product functions and widen the scope of application, and an improved structure and means of connection, which enhances bonding strength at the connection joint, increases resistance of the product to electric and mechanical shocks, so that the service life of the product is prolonged.

### FIELD OF THE INVENTION

The present invention relates to a vibration conduction and amplification device, and particularly relates to a vibration conduction and frequency-selective amplification device for a miniature moving-iron microphone/transducer apparatus, which belongs to the field of electro-acoustic and micro-mechanics.

### BACKGROUND OF THE INVENTION

At present, the commercial available vibration conduction devices for a moving-iron microphone/transducer are generally designed in a band-type mode or a thread-type mode. During usage, the vibration conduction device in the band-type mode is connected to an armature in an adhesive bonding manner, and the vibration conduction device in the thread-type mode is connected to an armature of the microphone/transducer in an arc discharge welding manner; while the vibration conduction device in each of the two aforesaid modes is connected to a vibration diaphragm in an adhesive bonding manner. However, there are universal deficiencies of the vibration conduction devices of prior art such as insufficient bonding strength, poor resistance to electric and mechanical shocks, complicated manufacturing process, high cost of manpower and equipments, poor capability of automatic mass production etc.; furthermore, determined by the mechanical structures of the vibration conduction devices of prior art, these devices only have the function of vibration conduction, which may not perform beneficial frequency-selective amplification on mechanical vibrations generated by the armature, which limits the application scope of the moving-iron microphone/transducer and weakens its competitive advantage.

### SUMMARY OF THE INVENTION

An objective of the present invention is to provide a vibration conduction and frequency-selective amplification device for a moving-iron microphone/transducer, which can effectively enhance the resistance of the microphone/transducer to electric and mechanical shocks and improve frequency response of the microphone/transducer to a great extent, meanwhile, advantages of the present invention include preferable manufacturability and low cost, so as to overcome the deficiencies of prior art.

In order to achieve the aforesaid objectives, the following technical solution is provided in the present invention:

A vibration conduction and frequency-selective amplification device for a moving-iron Microphone/transducer comprises a first connecting portion connected to an armature of the moving-iron microphone/transducer, a middle portion for vibration conduction and frequency-selective amplification, and a second connecting portion connected to a vibration diaphragm of the moving-iron microphone and transducer, the vibration conduction and frequency-selective amplification device is adapted for mechanically connecting the armature and the vibration diaphragm of the moving-iron microphone/transducer together in a welding and adhesion manner, and frequency-selectively amplifying vibrations generated by the armature and then conducting the vibrations onto the vibration diaphragm through the middle portion for vibration conduction and frequency-selective amplification, so as to achieve frequency-selective amplification and conversion from mechanical energy to acoustic energy.

Furthermore, the middle portion for vibration conduction and frequency-selective amplification of the vibration conduction and frequency-selective amplification device may be formed into various mechanical configurations, including but not limited to I-shape, C-shape and S-shape, according to different implementing purposes of frequency-selective Amplification.

Furthermore, the vibration conduction and frequency-selective amplification device is made of materials including but not limited to copper, aluminum, iron, stainless steel, aluminum magnesium alloy, or titanium alloy.

Furthermore, the vibration conduction and frequency-selective amplification device is manufactured by one-step forming process through punching, bending.

Furthermore, the vibration conduction and frequency-selective amplification device is connected to the armature of the moving-iron microphone/transducer in a resistance welding, laser welding or ultrasonic welding manner.

Furthermore, the vibration conduction and frequency-selective amplification device is connected to the vibration diaphragm of the moving-iron microphone/transducer in an adhesive bonding manner.

Furthermore, the vibration conduction and frequency-selective amplification device is connected to any one of the free moving end, the middle part or the driving end (the tail end) of the armature, according to different functional or technical requirements.

Compared to prior art, the present invention has the following advantages:

(1) In order to overcome the existing deficiencies of the band-type and the string-type vibration conduction devices of prior art, it is provided in the present invention that the welding area between the vibration conduction and frequency-selective amplification device and the armature in the microphone/transducer is enlarged so as to greatly enhance the bonding strength between the vibration conduction and frequency-selective amplification device and the armature of the microphone/transducer without influencing, the acoustic quality of the product, as well as to improve the resistance of the product to electric and mechanical shocks, so that the service life of the product is prolonged.

(2) The middle portion for vibration conduction and frequency-selective amplification may be formed into various mechanical configurations, including but not limited to I-shape, C-shape and S-shape, according to different implementing purposes of frequency-selective amplification, therefore, on the premise that the inherent function of vibration transmission of the conduction device is maintained, the function of frequency-selective amplification is added in, thereby the application scope of the product is greatly widened, and the frequency response of the microphone/transducer product is improved.

(3) The vibration conduction and frequency-selective amplification device and the armature is combined in a resistance welding, laser welding or ultrasonic welding manner, so that the manufacturability of the corresponding microphone/transducer product is substantially increased, and the process difficulty is reduced.

(4) The design of convenient one-step forming process of punching and bending facilitates manufacturing procedures of the vibration conduction and frequency-selective amplification device and reduces the cost.

(5) The device of the present invention is connected to any one of the free moving end, the middle part or the driving end (the tail end) of the armature, according to functional or technical requirements, which simplifies the manufacturing procedures of the microphone/transducer and reduces the manufacturing cost.

(6) Moreover, the vibration conduction and frequency-selective amplification device of the present invention may be made of various materials according to functional and technical requirements, thus the limitation thereof due to materials and processes is small and the practicability is strong.

### BRIEF DESCRIPTION OF THE DRAWINGS

FIG. 1 is a structural schematic diagram of a vibration conduction device in the band-type mode of prior art in connection with an armature of the microphone/transducer;

FIG. 2 is a structural schematic diagram of a vibration conduction device in the thread-type mode of prior art in connection with an armature of the microphone/transducer;

FIG. 3 is a cross-sectional structural schematic diagram of a vibration conduction and frequency-selective amplification device for a moving-iron microphone/transducer of the present invention;

FIG. 4 is a cross-sectional structural schematic diagram of the vibration conduction and frequency-selective amplification device for a moving-iron microphone/transducer of the present invention in connection with different portions of the armature;

FIG. 5 is a cross-sectional structural schematic diagram of I-shape, C-shape and S-shape mechanical configurations of the middle portion for vibration conduction and frequency-selective amplification of the vibration conduction and frequency-selective amplification device for a moving-iron microphone/transducer of the present invention;

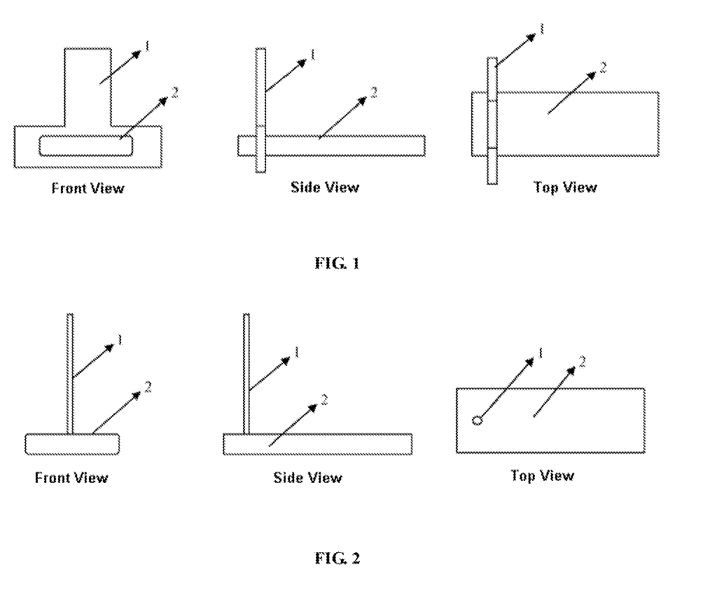

In the drawings, the following marking numerals are used 1-vibration conduction and frequency-selective amplification device, 2-armature, 3-vibration diaphragm, 4-magnetic conductive iron core, 5-magnet sheet, 6-magnetic induction coil, 7-magnetic shielding case, 8-signal wire of the magnetic induction coil, 9-sound output.

### DETAILED DESCRIPTION OF EMBODIMENTS

The technical solution of the present invention is further described below, in conjunction with accompanying drawings and a preferred embodiment.

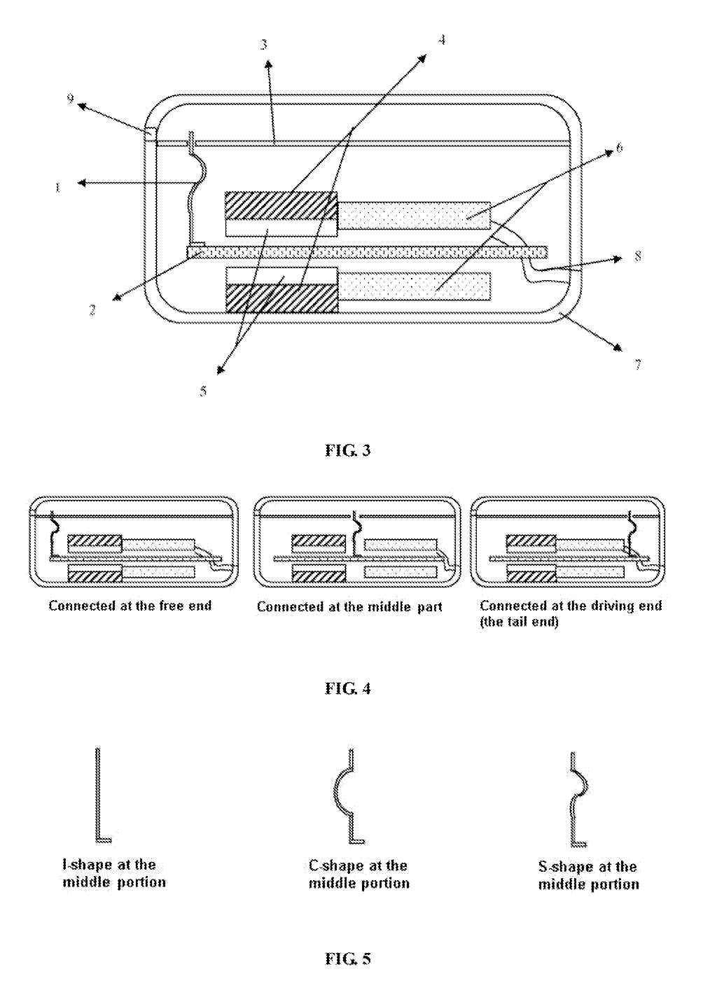

Referring to FIGS. 3-5, it is provided in this embodiment a vibration conduction and frequency-selective amplification device 1 for a moving-iron microphone/transducer, wherein, one end of the vibration conduction and frequency-selective amplification device 1 is in fixed connection with an armature 2, and the other end is in fixed connection with a vibration diaphragm 3, furthermore, the armature 2 is in fixed connection with an assembly provided with a magnetic conductive iron core 4, a plurality of magnet sheets 5, a magnetic induction coil 6 and signal wires 8 of the magnetic induction coil fixed to each other, which is further in connection with a magnetic shielding case 7 through the magnetic conductive iron core 4. Meanwhile the vibration diaphragm 3 is also in fixed connection with the magnetic shielding case 7. Furthermore, the signal wires 8 of the magnetic induction coil extend out of the magnetic shielding case 7 through a signal wire slot, adapted for connecting to external circuits to achieve the functions.

Preferably, the vibration conduction and frequency-selective amplification device 1 is in fixed connection with the armature 2 in a resistance welding, laser welding or ultrasonic welding manner.

The vibration conduction and frequency-selective amplification device 1 is in fixed connection with the vibration diaphragm 3 in an adhesive bonding manner.

The magnet sheets 5 are in fixed connection with the magnetic conductive iron core 4 in a resistance welding, laser welding or ultrasonic welding manner.

The magnetic induction coil 6 is in fixed connection with the magnetic conductive iron core 4 in an adhesive bonding manner.

The magnetic conductive iron core 4 is in fixed connection with the magnetic shielding case 7 in a resistance welding, laser welding or ultrasonic welding manner.

The armature 2 is in fixed connection with the assembly provided with the magnetic conductive iron core 4, the magnet sheets 5, the magnetic induction coil 6 and the signal wires 8 of the magnetic induction coil, in a resistance welding, laser welding or ultrasonic welding manner.

The vibration diaphragm 3 is in fixed connection with the magnetic shielding case 7 in an adhesive bonding manner.

The signal wires 8 of the magnetic induction coil extend out of the magnetic shielding case 7 through the signal wire slot.

The vibration conduction and frequency-selective amplification device 1 is preferably manufactured by one-step forming process of punching and bending into a certain mechanical configuration.

During the operation of the moving-iron microphone/transducer equipped with the vibration conduction and frequency-selective amplification device 1 of the present invention alternating current signal is introduced through the signal wires 8 of the magnetic induction coil which extend out of the signal wire slot of the magnetic shielding case 7. The alternating current signal is flowing through the magnetic induction coil 6, and thereby induces alternating magnetic field based on electro-magnetic inductive effect. The alternating magnetic field magnetizes the armature 2 arranged inside the magnetic induction coil 6, the magnetic conductive iron core 4 and the magnet sheets 5, thus a push-and-pull interaction occurs between the armature 2 and the magnet sheets 5 based on the principle of like poles repel and unlike poles attract, so as to drive the vibration conduction and frequency-selective amplification device 1 in fixed connection with the armature 2 to generate a vibration displacement in a direction orthogonal to the armature 2, and when the vibration displacement is transmitted to the middle portion for vibration conduction and frequency-selective amplification of the vibration conduction and frequency-selective amplification device 1, the middle portion for vibration conduction and frequency-selective amplification amplifies the vibration displacement frequency-selectively according to its mechanical configuration and subsequently transmit the frequency-selectively amplified vibration displacement to the vibration diaphragm 3 in fixed connection with the vibration conduction and frequency-selective amplification device 1, and thereby the vibration diaphragm 3 is driven to generate vibration which drives surrounding air to vibrate and generates a sound signal, so as to make a sound which comes out through a sound output 9 arranged at the front end of the magnetic shielding case 7, as a result, an energy conversion effect from electric energy to magnetic energy and then to mechanical energy and finally to acoustic energy is completed.

The present invention improves the design of mechanical structure and means of connection of the vibration conduction devices, and adds in brand new functions, so as to greatly enhance the bonding strength between the vibration conduction and frequency-selective amplification device and the armature of the microphone/transducer without influencing the acoustic quality of the product. Specifically, the present invention enlarges the welding area between the vibration conduction and frequency-selective amplification device and the armature in the microphone/transducer, and thereby enhances the resistance of the produce to electric and mechanical shocks, and the service life of the product is prolonged. Meanwhile, the present invention also provides a redesigned structure of the middle portion of vibration conduction devices, by forming the middle portion for vibration conduction and frequency-selective amplification into various mechanical configurations, including but not limited to I-shape, C-shape and S-shape, according to different implementing purposes of frequency-selective amplification, so that, on the premise that the inherent function of vibration transmission of the conduction device is maintained, the function of frequency-selective amplification is added in, and thereby the application scope of the product is greatly widened, and the frequency response of the microphone/transducer product is improved; moreover, in the improved structure, it is convenient to combine the vibration conduction and frequency-selective amplification device with the armature in a resistance welding, laser welding or ultrasonic welding manner, so that the manufacturability of the corresponding microphone/transducer product is substantially increased, and the process difficulty is reduced. The improved structure is also convenient to be manufactured by one-step forming process of punching and bending, so that the manufacturing procedure of the vibration conduction and frequency-selective amplification device is more simple and convenient, with lower cost. In addition, the device of the present invention is connected to any one of the free moving end, the middle part or the driving end (the tail end) of the armature, according to functional or technical requirements, which facilitates the manufacturing procedure of the microphone/transducer and reduces the manufacturing cost. Finally, the vibration conduction and frequency-selective amplification device of the present invention may be made of various materials according to functional and technical requirements, thus the limitation thereof due to materials and processes is small and the practicability is strong.

Further detailed description of the purposes, technical solution and beneficial effects of the present invention is given above, it should be understood that the aforementioned embodiments are merely preferred embodiments of the present invention and not intended for limiting the present invention, and any changes, equivalent alternatives or modifications made within the spirit and principle of the present invention are intended to be embraced within the protection scope of the present invention.

1-9. (canceled)

10. A vibration conduction and frequency-selective amplification device for a moving-iron microphone/transducer, comprising a first connecting portion connected to an armature of said moving-iron microphone/transducer, a middle portion for vibration conduction and frequency-selective amplification, and a second connecting portion connected to a vibration diaphragm of said moving-iron microphone/transducer, wherein,
said vibration conduction and frequency-selective amplification device is adapted for mechanically connecting said armature and said vibration diaphragm of said movable-iron microphone/transducer together in a welding and adhesion manner, and frequency-selectively amplifying vibrations generated by said armature and then conducting said vibrations onto said vibration diaphragm through said middle portion for vibration conduction and frequency-selective amplification, so as to achieve frequency-selective amplification and conversion from mechanical energy to acoustic energy.

11. The vibration conduction and frequency-selective amplification device for a moving-iron microphone/transducer of claim 10, wherein, said middle portion for vibration conduction and frequency-selective amplification of said vibration conduction and frequency-selective amplification device may be formed into various mechanical configurations, including but not limited to I-shape, C-shape and S-shape, according to different implementing purposes of frequency-selective amplification.

12. The vibration conduction and frequency-selective amplification device for a moving-iron microphone/transducer of claim 10, wherein, said vibration conduction and frequency-selective amplification device is made of materials including but not limited to copper, aluminum, iron, stainless steel, aluminum magnesium alloy, or titanium alloy.

13. The vibration conduction and frequency-selective amplification device for a moving-iron microphone/transducer of claim 11, wherein, said vibration conduction and frequency-selective amplification device is made of materials including but not limited to copper, aluminum, iron, stainless steel, aluminum magnesium alloy, or titanium alloy.

14. The vibration conduction and frequency-selective amplification device for a moving-iron microphone/transducer of claim 12, wherein, said vibration conduction and frequency-selective amplification device is manufactured by one-step forming process through punching and bending.

15. The vibration conduction and frequency-selective amplification device for a moving-iron microphone/transducer of claim 13, wherein, said vibration conduction and frequency-selective amplification device is manufactured by one-step forming process through punching and bending.

16. The vibration conduction and frequency-selective amplification device for a moving-iron microphone/transducer of claim 10, wherein, said vibration conduction and frequency-selective amplification device is connected to said armature of said moving-iron microphone/transducer in a resistance welding, laser welding or ultrasonic welding manner.

17. The vibration conduction and frequency-selective amplification device for a moving-iron microphone/transducer of claim 11, wherein, said vibration conduction and frequency-selective amplification device is connected to said armature of said moving-iron microphone/transducer in a resistance welding, laser welding or ultrasonic welding manner.

18. The vibration conduction and frequency-selective amplification device for a moving-iron microphone/transducer of claim 10, wherein, said vibration conduction and frequency-selective amplification device is connected to said vibration diaphragm of said moving-iron microphone/transducer in a adhesive bonding manner.

19. The vibration conduction and frequency-selective amplification device for a moving-iron microphone/transducer of claim 11, wherein, said vibration conduction and frequency-selective amplification device is connected to said vibration diaphragm of said moving-iron microphone/transducer in a adhesive bonding manner.

20. A moving-iron microphone/transducer, wherein, said moving-iron microphone/transducer comprises a vibration conduction and frequency-selective amplification device of claim 10, an armature, a vibration diaphragm, a magnetic conductive iron core, a plurality of magnet sheets, a magnetic induction coil, and a magnetic shielding case.

21. A moving-iron microphone/transducer, wherein, said moving-iron microphone/transducer comprises a vibration conduction and frequency-selective amplification device of claim 11, an armature, a vibration diaphragm, a magnetic conductive iron core, a plurality of magnet sheets, a magnetic induction coil, and a magnetic shielding case.

22. A moving-iron microphone/transducer, wherein, said moving-iron microphone/transducer comprises a vibration conduction and frequency-selective amplification device of claim 12, an armature, a vibration diaphragm, a magnetic conductive iron core, a plurality of magnet sheets, a magnetic induction coil, and a magnetic shielding case.

23. A moving-iron microphone/transducer, wherein, said moving-iron microphone/transducer comprises a vibration conduction and frequency-selective amplification device of claim 13, an armature, a vibration diaphragm, a magnetic conductive iron core, a plurality of magnet sheets, a magnetic induction coil, and a magnetic shielding case.

24. A moving-iron microphone/transducer, wherein, said moving-iron microphone/transducer comprises a vibration conduction and frequency-selective amplification device of claim 14, an armature, a vibration diaphragm, a magnetic conductive iron core, a plurality of magnet sheets, a magnetic induction coil, and a magnetic shielding case.

25. A moving-iron microphone/transducer, wherein, said moving-iron microphone/transducer comprises a vibration conduction and frequency-selective amplification device of claim 15, an armature, a vibration diaphragm, a magnetic conductive iron core, a plurality of magnet sheets, a magnetic induction coil, and a magnetic shielding case.

26. The moving-iron microphone/transducer of claim 16, wherein,
said magnetic induction coil is adapted for inducing an alternating magnetic field from alternating current flowing therethrough via a signal wire, and further magnetizing said armature arranged inside said magnetic induction coil, said magnetic conductive iron core and said magnet sheets;
said armature is adapted for pushing or pulling said magnet sheets based on the principle of like poles repel each other and unlike poles attract each other, so as to drive said vibration conduction and frequency-selective amplification device welded on said armature to generate a vibration displacement in a direction orthogonal to said armature; said middle portion for vibration conduction and frequency-selective amplification is adapted for frequency-selectively amplifying said vibration displacement according to its mechanical configuration when said vibration displacement is transmitted thereto, and for subsequently conducting a frequency-selectively amplified vibration displacement onto said vibration diaphragm connected to said vibration conduction and frequency-selective amplification device;
said vibration diaphragm is adapted for being driven to generate vibrations which drive surrounding air to vibrate, so as to make a sound and complete an energy conversion effect from electric energy to magnetic energy and further to mechanical energy and finally to acoustic energy.

27. The moving-iron microphone/transducer of claim 11, wherein, said vibration conduction and frequency-selective amplification device is connected to any one of the free moving end, the middle part or the driving end (the tail end) of said armature, according to different functional or technical requirements.

28. The moving-iron microphone/transducer of claim 12, wherein, said vibration conduction and frequency-selective amplification device is connected to any one of the free moving end, the middle part or the driving end (the tail end) of said armature, according to different functional or technical requirements.
